(19) United States
(12) Patent Application Publication
(10) Pub. No.: US 2011/0286746 A1
(43) Pub. Date: Nov. 24, 2011

(54) Transponder Aggregator Without Wavelength Selector for Colorless and Directionless Multi-Degree ROADM Node

(75) Inventors: Philip Nan Ji, Princeton, NJ (US); Yoshiaki Aono, Tokyo (JP); Jianjun Yu, Princeton, NJ (US); Ting Wang, West Windsor, NJ (US); Tsutomu Tajima, Tokyo (JP); Makoto Shibutani, Tokyo (JP)

(73) Assignee: NEC LABORATORIES AMERICA, INC., Princeton, NJ (US)

(21) Appl. No.: 12/900,220

(22) Filed: Oct. 7, 2010

Related U.S. Application Data
(60) Provisional application No. 61/250,185, filed on Oct. 9, 2009.

(51) Int. Cl. H04J 14/02

(52) U.S. Cl. 398/83

(57) ABSTRACT

A method for transponder optical channel selection of optical signals from a transponder aggregator includes choosing wavelength division multiplexing channels to be dropped from a transponder aggregator receiving optical input signals, splitting all dropped wavelength division multiplexing channels into at least one transponder having a coherent receiver and transmitter, and tuning a local oscillator laser of the coherent receiver to a wavelength of one of the all dropped wavelength division multiplexing channels for selecting one of the all dropped wavelength division multiplexing channels.

This application claims the benefit of U.S. Provisional Application No. 61/250,185, entitled “Transponder Aggregator without Wavelength Selector for Colorless and Directionless Multi-Degree ROADM Node”, filed on Oct. 9, 2009, the contents of which are incorporated by reference herein.

### FIELD OF THE INVENTION

The present invention relates generally to optical communications, and more particularly, to a transponder aggregator without a wavelength selector for colorless and directionless multi-degree reconfigurable optical add/drop multiplexing ROADM node.

### BACKGROUND OF THE INVENTION

The reconfigurable optical add/drop multiplexing ROADM node has been widely deployed in long haul and metro wavelength division multiplexing WDM networks in the past few years. It allows the flexible adding and dropping of any or all WDM channels at the wavelength layer. A multi-degree ROADM node (a node with 3 degrees or higher) also provides a cross-connection function of WDM signals among different paths.

As traffic of the global optical network becomes more dynamic and the network topologies evolve from ring to mesh or meshed ring, the current ROADM nodes exhibit some limitations. In particular, (1) the colored transponder assignment issue where each transponder corresponds to a fixed wavelength and therefore all transponders need to be preinstalled (high capital expenditure) or manually provisioned during system reconfiguration and upgrade (high operation expenditure), and (2) the directed add/drop switching issue where the add/drop operation of each degree in the node is separate and the transponders cannot be shared among different degrees, which limits the network's routing, restoration and rerouting capability.

To overcome these limitations, the ROADM node needs to have colorless and directionless (CL&DL) function. In such a ROADM, the add/drop ports are not wavelength specific and any channel from any input port can be dropped to any transponder connected to the node, and each transponder can be tuned to any dense wavelength division multiplexing DWDM channel. Similarly, each added channel can be switched to any output port, regardless of which input port the corresponding drop signal came from. These features allow full automation of wavelength assignment with pay-as-you-grow investment strategy, as well as more efficient sharing of transponders in a node among different paths and better protection scheme.

The most straightforward method to achieve CL&DL switching is to fully demultiplex all the input channels from all input ports, and use a large dimension fiber switch to switch these individual input channels and individual newly added channels to respective output ports or drop ports [1]. It requires a large fiber switch (also called spaced switch or photonics cross-connect) with the dimension of [(L+K)×N]×[(L+K)×N] where N is the node degree, K is the total number of DWDM channels from each input, and L is the maximum number of local add/drop channels per degree. This is not practical because the large dimension fiber switch is costly and it presents the potential problem of single source of failure.

The common method is to have a dedicated subsystem to CL&DL switching operation. We call it the Transponder Aggregator (TA), illustrated in block form in FIG. 1. In a TA, all channels to be dropped locally are combined through an aggregation device such as wavelength-selective switch (WSS) or coupler. These aggregated drop channels are sent to respective transponders through a channel separation unit. For the add side, the added signals are combined, then multicast and selected by appropriate output ports.

All the TA designs so far require some wavelength selective element to do channel separation before the signals reach the transponders. In Method 1, the n aggregated drop channels are demultiplexed using an optical demultiplexer with fixed wavelength assignments, followed by an n×n fiber switch for channel selection FIG. 2(a). In Method 2, a 1×n WSS selects and sends each of the n drop channels to the respective output port, which connects to the targeted transponder, FIG. 2(b). Since the WSS with port count higher than 1×9 is not commercially available yet, the drop signals can be split into x parts first using a 1:x optical splitter, and then use x units of standard WSS to separate them, Method 3, FIG. 2(c). Here x=┌n/9┐ if 1×9 WSS's are used. Method 4 uses 1:n optical splitter to broadcast the drop channels into n equal shares, and then uses an array of n tunable filters to select the channel for each transponder, FIG. 2(d). All these methods use some wavelength selector, such as a demultiplexer, WSS, or optical filters. These devices are costly, and they require more space due to complicated optics

Accordingly, there is a need for overcoming the limitations of existing ROADM techniques. The ROADM node needs to have a colorless and directionless (CL&DL) function. In such an ROADM, the add/drop ports are not wavelength specific and any channel from any input port can be dropped to any transponder connected to the node, and each transponder can be tuned to any DWDM channel. Similarly, each added channel can be switched to any output port, regardless of which input port the corresponding drop signal came from. These features allow full automation of wavelength assignment with pay-as-you-grow investment strategy, as well as more efficient sharing of transponders in a node among different paths and better protection scheme.

### SUMMARY OF THE INVENTION

In one aspect of the invention, a method for transponder optical channel selection of optical signals from a transponder aggregator includes choosing wavelength division multiplexing channels to be dropped from a transponder aggregator receiving optical input signals, splitting all dropped wavelength division multiplexing channels into at least one transponder having a coherent receiver and transmitter, and tuning a local oscillator laser of the coherent receiver to a wavelength of one of the all dropped wavelength division multiplexing channels for selecting one of the all dropped wavelength division multiplexing channels.

In an alternative aspect of the invention, an optical configuration includes a transponder aggregator for choosing wavelength division multiplexing channels to be dropped responsive to received input signals; and at least one transponder coupled to the transponder aggregator and having a coherent receiver and transmitter, the transponder selecting one of the wavelength division multiplexing channels dropped through tuning of a local oscillator laser in the coherent receiver to a wavelength of one of the wavelength division multiplexing channels dropped.

### BRIEF DESCRIPTION OF DRAWINGS

These and other advantages of the invention will be apparent to those of ordinary skill in the art by reference to the following detailed description and the accompanying drawings.

FIG. 1 is a block diagram of a 3-degree colorless and directionless ROADM node with an inset schematic of an exemplary transponder aggregator.

FIG. 2 is a diagram illustrating channel selection methods in a transponder aggregator according to the prior art: (a) Using fixed demultiplexer and fiber switch; (b) Using high port count WSS; (c) Using splitter and standard WSS; (d) Using splitter and tunable filter array.

FIG. 3 is a diagram of channel selection for a transponder aggregator without a wavelength selector, according to the invention.

FIG. 4 is a block diagram of channel selection by a transponder aggregator with a wavelength selector, with colorless transponders, a coherent receiver and an add/drop operation between them, in accordance with the invention.

FIG. 5 is a block diagram of an exemplary N-degree ROADM node employing the inventive transponder aggregator with a wavelength selector.

FIG. 6 is a block diagram if a alternative exemplary N-degree ROADM node employing the inventive transponder aggregator without a wavelength selector.

FIG. 7 is a special case of FIG. 4 where the node is a terminal node where the degree is 1.

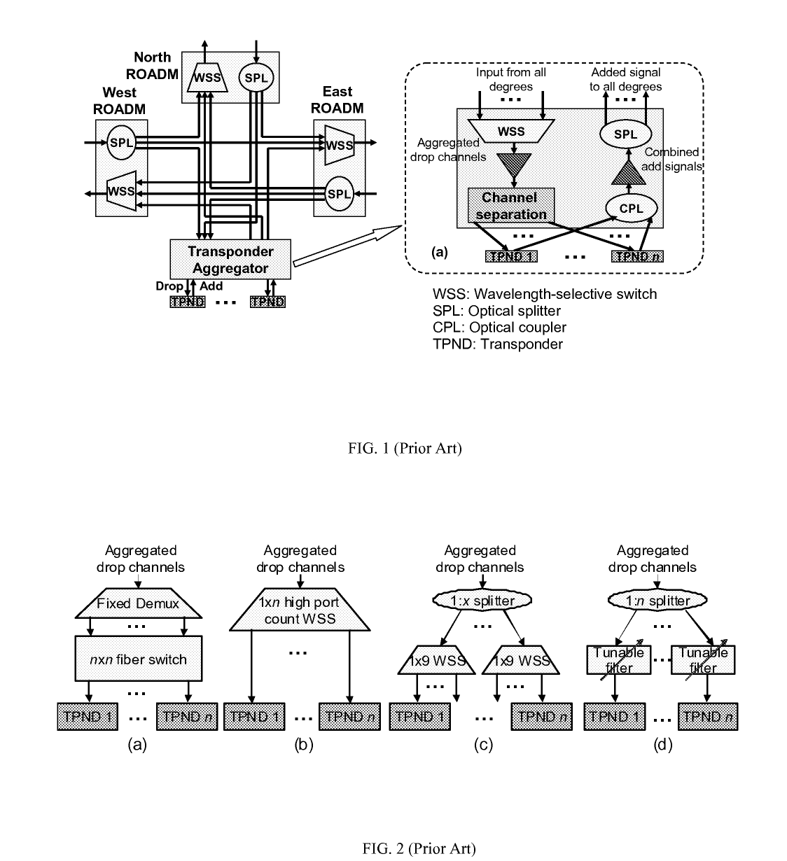

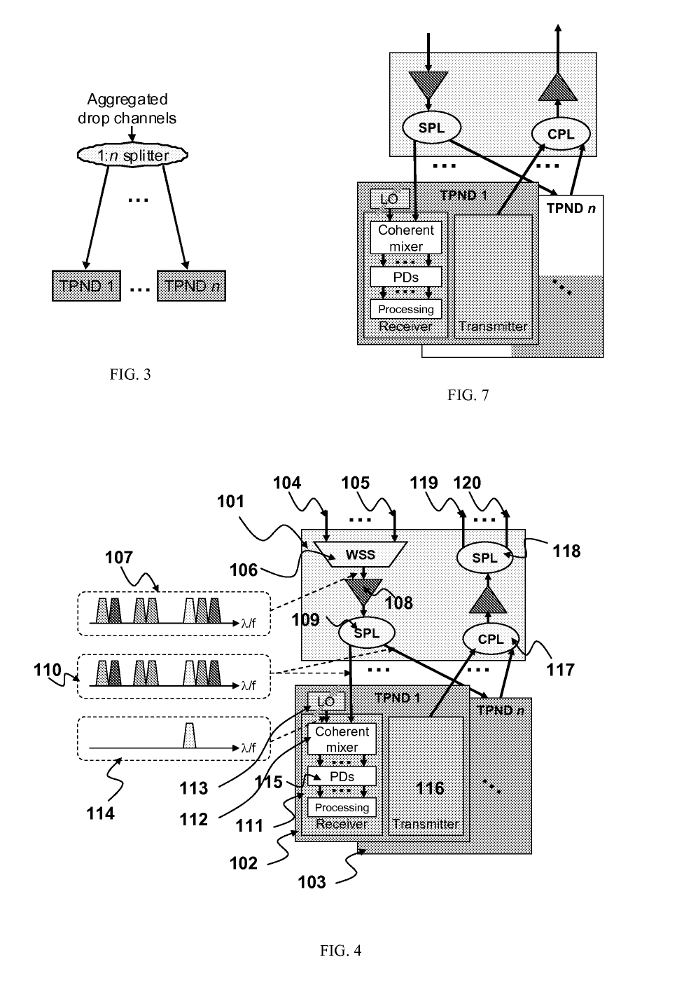

### DETAILED DESCRIPTION

The invention is directed to the use a transponder aggregator TA to achieve colorless and directionless add/drop in the multi-degree ROADM node without the use of a wavelength selector in the TA. It is applicable to a system with a coherent receiver. With the inventive technique, the channel separation unit only contains a passive 1:n splitter, which splits the drop channels into n equal parts. This is similar to Method 4 above, however, tunable filters are not required to select one channel for each transponder, instead each transponder receives all of the n WDM channels. The channel selection is performed within the transponder through tuning the wavelength of the local oscillator laser in the coherent receiver. This laser is tunable since the transponders are tunable in colorless ROADM. Theoretical and experimental studies show that this method provides similar performance to the existing methods.

Referring now to FIG. 4, showing a TA (101) without wavelength selector and some transponders linked to the TA (102, 103). The TA (101) receives the input signals from different input ports (degrees) of the node (104, 105), and use a wavelength selective switch (106) to select the WDM channels that need to be dropped in the TA. The maximum number of dropped channels for the TA is denoted as n. These channels are illustrated in the spectrum 107. These signals are amplified by an optical amplifier (108) and sent to a 1:n optical splitter (109). Each of the n splitter outputs (110) has the same number of drop channels as 107. Each splitter output is connected to the input of a transponder (such as 102, 103). The receiver (111) of the transponder uses coherent receiving technique. It contains a coherent mixer (or called 90 degree optical hybrid, it can be polarization-insensitive coherent mixer or polarization diversity coherent mixer) (112), which mixes the input dropped signal (110) and a CW signal from a local oscillator laser (113). Since this is for colorless ROADM, each transponder is colorless, which means that the local oscillator laser is tunable. Its wavelength is tuned to a single particular WDM channel (114) which has the wavelength of the targeted drop channel. Using the technique, despite the transponder receives multiple WDM channels from the TA, only the specific target channel will be received due to coherent receiving technology. The coherent mixer produces different vectorial additions of the LO and the targeted drop channel signal, which is then detected by array of photodiodes (115) and processed to recover the data. Both single-ended photodetectors and balanced photodetectors can be used in 115. However, balanced photodetectors delivers better performance because it has lower common mode rejection ratio (CMRR) and will thus reduce the interference from unwanted channels, so it is recommended. This also requires the coherent mixer (112) to have balanced outputs.

For the add side, the corresponding added signals from the transmitters (such as 116) in the transponders (102, 103) are combined by an optical coupler (117), amplified, and split by an optical splitter (118) to different outputs (different degrees, 119, 120).

FIG. 5 shows an example of an N-degree ROADM node with such a TA. This node consists of N single-degree ROADM modules (201, 202) and N transponder aggregators working in parallel (203, 204). Each ROADM module contains optical splitter (205, 206) and performs cross-connect function between degrees and sends Drop channel to the TAs, then combines the signal from other degrees and the Added signals using WSS (207, 208) to produce the output for each degree without wavelength contention. Each of these N transponder aggregators (203, 204) has the configuration as shown on FIG. 4 above, and connects to n colorless transponders. So altogether there are N×n transponders in the node. These transponders form a transponder bank (209).

It is to be noted that FIG. 5 includes some upgrade ports (shown in red and green arrows), and does not show the optical amplifiers. Since the amplifiers in the add side of the TA are not shown, the coupler (117) and splitter (118) are shown as a combined coupler (210, 211). This is the same for the exemplary configuration of FIG. 6, discussed below.

Again, in this architecture example, the TAs are replaced with the current invention of TA without wavelength selector, and therefore, it does not have wavelength contention issue, and offers good modularity and in-service upgradeability in both node degree upgrade and add/drop port upgrade.

FIG. 6 shows another example of an N-degree ROADM node using the proposed TA. It only contains 1 TA unit. It's for applications that have tradeoff between add/drop wavelength contention issue and lower hardware cost, or applications where wavelength contention issue is reduced through proper wavelength assignment scheme.

It consists of N single-degree ROADM modules (301, 302) and 1 transponder aggregators working in parallel (303). Each ROADM module contains optical splitter (305, 305) and performs cross-connect function between degrees and send Drop channel to the TA, then combine the signal from other degrees and the Added signals using WSS (306, 307) to produce the output for each degree without wavelength contention. The N transponder aggregator (303) has the configuration as shown on FIG. 4 above, and connects to n colorless transponders.

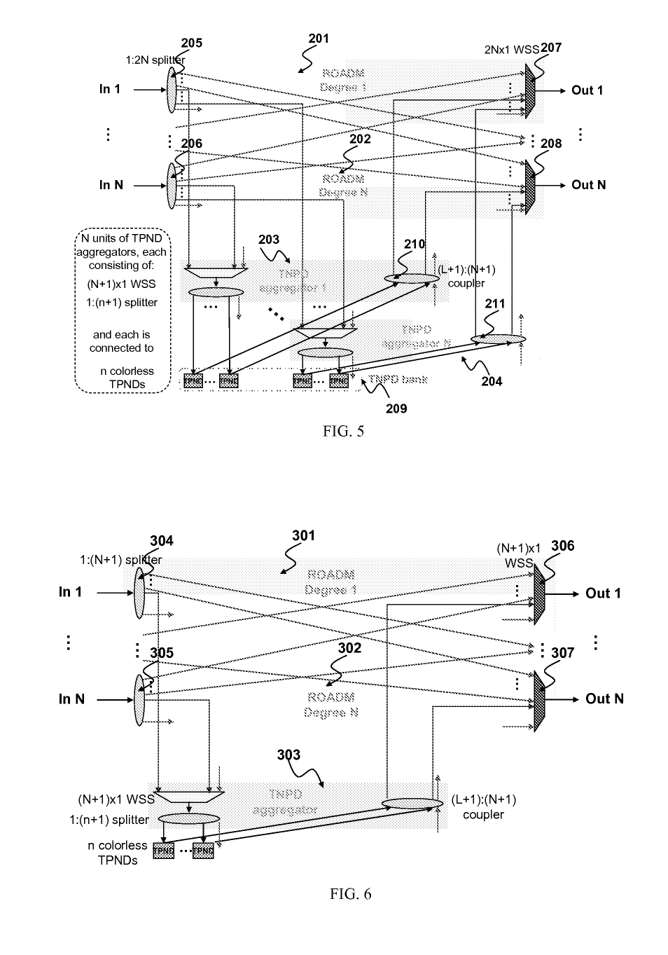

A special case for the TA without wavelength selector is a terminal node, which only contains 1 input port (1 degree). Here the TA can be simplified by removing the WSS (106) and the splitter (118). All input channels are dropped and received by the transponders. This is shown in FIG. 7. The same transponder optical channel selection can be applied.

It can be appreciated that the inventive technique can significantly reduce the hardware cost of the CL&DL ROADM node (because the active wavelength selectors such as demultiplexer, WSS and tunable filter array are expensive), reduce the equipment footprint (also due to the removal of the wavelength selectors, which are usually bulky due to the complicated optics and control circuitry), and reduce the power consumption (the channel separation unit is now completely passive and does not consume any electrical power).

The present invention has been shown and described in what are considered to be the most practical and preferred embodiments. It should be noted that FIG. 5 and FIG. 6 depict just 2 examples, according to the invention. There are other alternatives and modifications to the multi-degree ROADM node architecture. As long as they use TA (others might call it different name) and the receiver uses coherent receiving technology, the proposed TA design can be applied.

It is anticipated, however, that departures may be made therefrom and that obvious modifications will be implemented by those skilled in the art. It will be appreciated that those skilled in the art will be able to devise numerous arrangements and variations, which although not explicitly shown or described herein, embody the principles of the invention and are within their spirit and scope.

What is claimed is:

1. A method for transponder optical channel selection of optical signals from a transponder aggregator, said method comprising the steps of:
choosing wavelength division multiplexing channels to be dropped from a transponder aggregator receiving optical input signals;
splitting all dropped wavelength division multiplexing channels into at least one transponder having a coherent receiver and transmitter; and
tuning a local oscillator laser of said coherent receiver to a wavelength of one of said all dropped wavelength division multiplexing channels for selecting one of said all dropped wavelength division multiplexing channels.

2. The method of claim 1, wherein said step of choosing comprises a wavelength selector switch for selecting said wavelength division multiplexing channels to be dropped.

3. The method of claim 1, wherein said tuning comprises mixing said all dropped wavelength division multiplexed channels with a continuous wave signal from said local oscillator.

4. The method of claim 1, wherein said tuning comprises tuning said local oscillator laser to a wavelength corresponding to one of said all dropped wavelength division multiplexing channels for being received by a coherent mixer.

5. The method of claim 1, wherein said tuning comprises producing different vectorial additions of said local oscillator laser and one of said all dropped wavelength division multiplexing channels.

6. The method of claim 5, wherein said tuning comprises detecting different vectorial additions of said local oscillator laser tuned to a wavelength of one of said all dropped wavelength division multiplexing channels by an array of photodetectors for recovering data from one of said all dropped wavelength division multiplexing channels

7. The method of claim 6, wherein said photodetectors are one of single-ended photodetectors and balanced photodetectors.

8. The method of claim 4, wherein said coherent mixer comprises balanced outputs.

9. An optical configuration comprising:
a transponder aggregator for choosing wavelength division multiplexing channels to be dropped responsive to received input signals; and
at least one transponder coupled to said transponder aggregator and having a coherent receiver and transmitter, said transponder selecting one of said wavelength division multiplexing channels dropped through tuning of a local oscillator laser in said coherent receiver to a wavelength of one of said wavelength division multiplexing channels dropped.

10. The optical configuration of claim 9, wherein said transponder aggregator comprises a wavelength selector switch for choosing said wavelength division multiplexing channels to be dropped.

11. The optical configuration of claim 9, wherein coherent receiver comprises a mixer for mixing said dropped wavelength division multiplexed channels with a continuous wave signal from said local oscillator.

12. The optical configuration of claim 9, wherein said mixing produces different vectorial additions of said local oscillator laser and one of said dropped wavelength division multiplexing channels.

13. The optical configuration of claim 12, wherein said coherent receiver detects different vectorial additions of said local oscillator laser tuned to a wavelength of one of said dropped wavelength division multiplexing channels by an array of photodetectors for recovering data from one of said dropped wavelength division multiplexing channels.

14. The optical configuration of claim 13, wherein said photodetectors are one of single-ended photodetectors and balanced photodetectors.

15. The optical configuration of claim 4, wherein said coherent receiver comprises a mixer having balanced output.
